(19) United States
(12) Patent Application Publication
(10) Pub. No.: US 2008/0180952 A1
(43) Pub. Date: Jul. 31, 2008

(54) Structure of the christmas light

(76) Inventors: Shun-Feng Huang, Taichung County (TW); Mei-Lu Lin, Fongyuan City (TW)

Correspondence Address: SHUN-FENG HUANG, P.O. Box 697, Fongyuan City 420, Taichung County, omitted

(21) Appl. No.: 11/700,163

(22) Filed: Jan. 31, 2007

(51) Int. Cl. H05B 33/02

(52) U.S. Cl. 362/293

(57) ABSTRACT

A structure of the Christmas light including a tubular socket having a pair of narrow notchs in opposing peripheries of the bottom abutting two pair of rectangular clamps on the bottom opposite to the narrow hole to define a pair of narrow gaps therebetween, a lamp inserted into the top of the socket having a base, a bulb, a pair of lead-in wires an isolation isle in the bottom of the base around the bulb and a pair of retaining holes in opposing peripheries of the base, a transparent outer cap having a reduced lower end inserted into the base and a pair of wedge retaining blocks on opposing peripheries of the reduced lower end engaged with the retaining holes of the base, a pair of electric wires each having a contact plate at inner end inserted into the socket and engaged with the lead-in wires. The electric wires are bent for 90 degrees and gripped by the narrow notchs and the rectangular clamps and went to opposing directions.

### BACKGROUND OF THE INVENTION

The present invention relates to Christmas light and more particularly to a structure of the Christmas light which has a transparent outer cap and bent for 90 degrees electric wires. The transparent outer cap is fixed without rotating, breaking-off and heat conducting. The bent electric wires are capable of resisting against outer tensions which is not affecting the contact of the contact plates with the lead-in wires.

Conventional Christmas 90 (as shown FIG. 9) comprises a socket 91 for receiving a lamp 92 therein. The lamp 92 has a bulb 93 having a pair of lead-in wires 931 contacting to a pair of electric wires 94 for supplying the electric current to light the bulb 93. This structure is follow for long time without any changes. Due to that most of the Christmas lights are decorated at outdoor, their sockets 91 are easily immersed with the water of training and snowing. Recently, some of the producers produces a covered Christmas light to which a screwed transparent cap is covered on the socket 91. However, this cap is always broken off for inadvertent rotation, such that this cap could not effectively form a waterproof for the Christmas light. That is a first disadvantage of it.

Its second disadvantage is that the lower end of the cap is almost contact with the bulb 93 that not only causes the poor radiation for the bulb 93, but also causes the high heat accumulating on lower end of the cap which may melt the cap to destroy (the cap is thin and transparent and is made of different material from the bulb 93).

Its third disadvantage is that the lead-in wires 931 of the bulb 93 disconnect with the electric wires 94 because of that the electric wires 94 are drawn outward from the socket 91.

### SUMMARY OF THE PRESENT INVENTION

The present invention has a main object to provide a structure of the Christmas light to which a transparent outer cap fixedly secure to the socket without rotating such that the cap will not break-off.

Another object of the present invention is to provide a structure of the Christmas light which has a isolation isle in the socket to isolate the bulb from the cap. So that the cap shall not be melted.

Still another object of the present invention is to provide a structure of the Christmas light in which a pair of the electric wires are bent for 90 degrees relative to the longitudinal direction of the socket and fixed by the rectangular clamps on the lower end of the socket and departed for opposite directions so as to change the direction of application for the outer tensions.

Accordingly, the structure of the Christmas light of the present invention comprise generally:

a socket having an inserting space in the body, a pair of narrow holes in the bottom thereof, two pairs of the rectangular clamps under the narrow holes to define a pair of narrow slits therebetween,

a lamp engaged within the inserting space of the socket having bulb in a base, a pair of lead-in wires from the bulb and exposed out of the bottom of the base, a pair of retaining holes symmetrically formed in the opposite side of the base and an isolating isle around the bottom of the bulb,

a transparent outer cap inserted into the base of the lamp having a reduce lower end and a pair of wedge retaining blocks symmetrically formed on opposite side of the reduced lower end to engaged within the pair of the retaining holes of the base of the lamp, the bottom of the cap is isolated from the bulb by the isolating isle of the base of the lamp,

a pair of electric wires each having contact plate on inner end inserted into the inlaid grooves of the socket and engaged with the lead-in wires respectively,

wherein, the cap is fixed by the retaining holes and isolated from the bulb by the isolating isle will not be breaking-off or melted and the electric wires being bent for 90 degrees and restrainted respectively by the narrow holes and the rectangular clamps are changed the application point of the outer tensions and not to be breaking-off with the lead-in wires.

The present invention will become more fully understood by reference to the following detailed description thereof when read in conjunction with the attached drawings.

### BRIEF DESCRIPTION OF THE DRAWINGS

FIG. 1 is an exploded perspective view of the first embodiment of the structure of the Christmas light of the present invention,

FIG. 2 is a perspectively to show the assembly of FIG. 1,

FIG. 3 is a perspective view to show the upside-down of FIG. 2,

FIG. 4 is a section view of FIG. 2,

FIG. 5 is the bottom view of FIG. 2,

FIG. 6 is an exploded perspectively view of a second embodiment of the structure of the Christmas light of the present invention,

FIG. 7 is a perspective view to show the assembly of FIG. 6,

FIG. 8 is a longitudinal sectional view taken along line 7-7 of FIG. 7,

FIG. 9 is a cross sectional view taken along line 7′-7′ of FIG. 7,

FIG. 10 is a sectional view to show a Christmas light according to a prior art.

### DETAILED DESCRIPTION OF THE PREFERRED EMBODIMENT

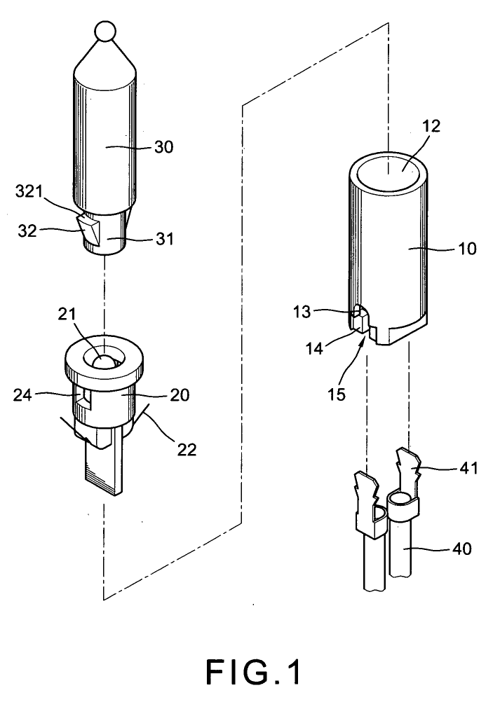

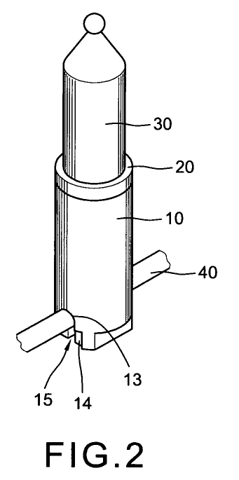

With reference to the drawings and initiated from FIGS. 1, 2 and 3, the first embodiment of the structure of the Christmas light of the present invention comprises:

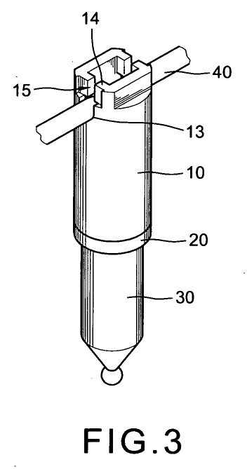

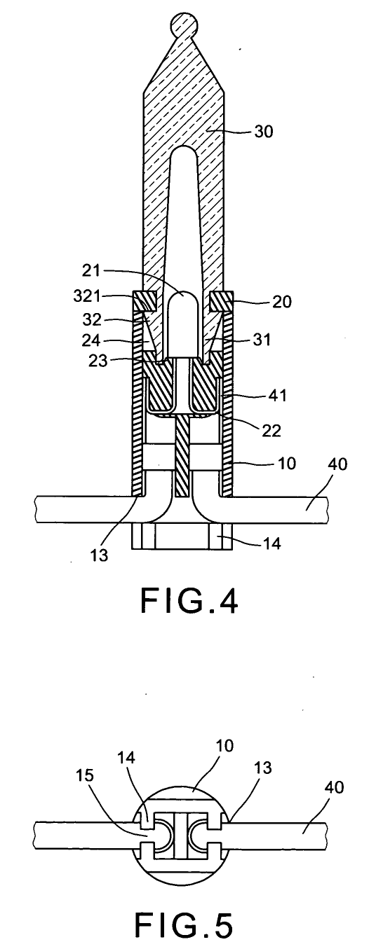

a tubular socket 10 having an inlaid space 12 in the top, a pair of narrow holes 13 symmetrically formed in opposite peripheries of the bottom thereof (as show in FIGS. 3, 4 and 5), the narrow holes 13 which is about ¾ arcuate portion has a inner diameter slightly less than the outer diameter of the electric wires 40, two pairs of the spaced rectangular clamps 14 symmetrically formed on two sides of the bottom thereof opposite to the narrow holes 13 to define a pair narrow gaps 15 therebetween, the width of the gaps 15 are far less than the outer diameter of the electric wires 40 so as to prevent the electric wires from downward movement, the electric wires 40 each having contact plate 41 inlaid inside the socket 10, a lamp 20 engaged within the inlaid space 12 of the socket 10 having a base, a bulb 21 in the base including a pair of lead-in wires 22 exposed to outside of the bottom of the base and engaged with the contact plates 41 of the electric wires 40 respectively, an isolation isle 23 under the bulb 21 and a pair of retaining holes 24 symmetrically formed in opposite peripheries of the base, a transparent outer cap 30 which is diaphaneity and/or colorful having a reduced lower end 31 including a pair of wedge retaining blocks 32 with a plain upper surface 321 symmetrically formed on opposite side of the reduced lower end 31. When the cap 30 is inserted into the lamp 20, the pair of wedge retaining blocks 32 are fixedly secured within the retaining holes 24 of the base and the reduced lower end thereof is isolated by the isolation isle 23 from the bulb 21 such that the cap will not be breaking-off from the lamp 20 and its reduced lower end will not be melted by the bulb 21.

This embodiment has the following advantages:

1) the wedge retaining blocks 32 of the transparent outer cap 30 fixedly engaged within the retaining holes 24 of the lamp 20 is to prevent the cap 30 from breaking-off for rotation,

2) the isolation isle 23 desposed between the bulb 21 and the reduced lower portion 31 of the outer cap 30 is to prevent the lower portion 31 from melted by the heat of the bulb 21 which also has a radiation space,

3) the electric wires 40 are retained by the narrow holes 13 and bent for 90 degrees that changes the direction of the outer tensions, the application point of the outer tensions accumulates at the 90 degrees turning point and not affects the engagement between the contact plates 41 and lead-in wires 22.

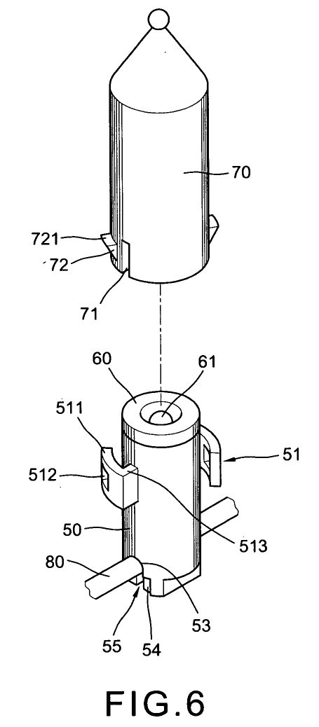

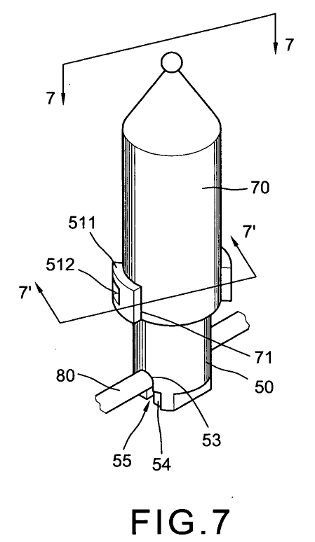

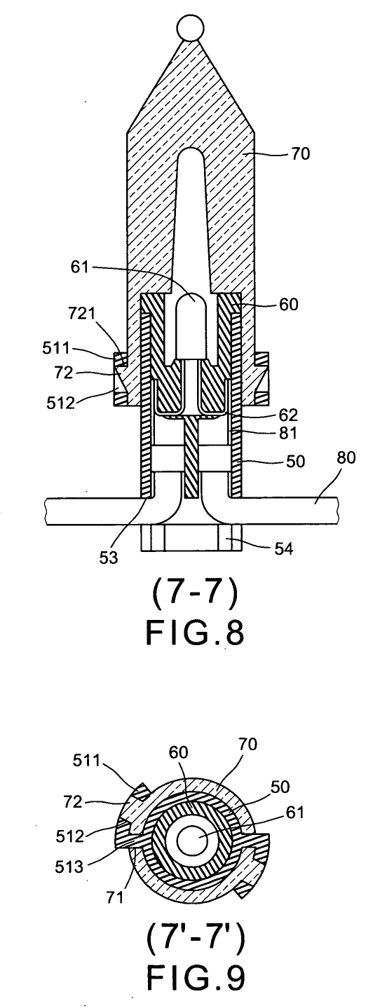

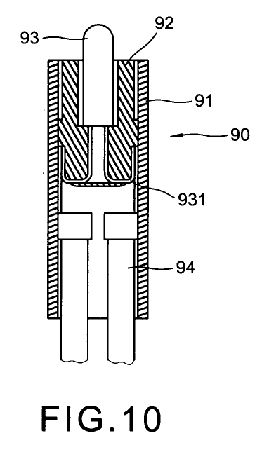

Referring to FIGS. 6, 7, 8 and 9, a second embodiment of the structure of the Christmas light of the present invention is provided. This embodiment is principally engaging the transparent cuter cap 70 on the outer periphery of the socket and comprises a socket 50, a lamp 60, a transparent outer cap 70 and a pair of electric wires 80. The socket 50 has a pair of narrow holes 53 symmetrically formed in the opposite side of the bottom slightly narrower than the diameter of the electric wires 80, two pair of the rectangular clamps 54 symmetrically formed on the sides opposite to the narrow holes 53 to define a pair of narrow gaps 55 therebetween, a pair of ears 51 symmetrically formed on opposing middle peripheries each having an arcuate portion 511, a retaining hole 512 and a straight portion 513. The lamp 60 has a base, a bulb 61 and a pair of lead-in wires 62 inserted into the top of the socket 50. The transparent outer cap 70 has a pair of notchs 71 in the opposing peripheries of the bottom thereof and a pair of wedge retaining blocks 72 including a plain top surface 721 symmetrically formed on the opposing peripheries a butting the notchs 71. When the cap 70 wraps on upper periphery of the socket 50, the notchs 71 are astride over the straight portions 513 of the ears 51 and the wedge retaining blocks 72 are engaged within the retaining holes 512 of the ears 51 (as shown in FIG. 9). The electric wires 80 each has a contact plate 81 on inner end inserted into the socket 50 and engaged with the lead-in wires 62 respectively, the electric wires 80 itselves are bent for 90 degrees to respectively clamp by the narrow holes 53 and the rectangular clamps 54 going to opposing directions.

The second embodiment has to following advantages:

1) the transparent outer cap 70 fixedly engages with the ears 51 of socket 50 to ensure the cap 70 not to be breaking-off for any rotations,

2) the cap 70 positions outside the socket will not melt by the bulb 61 which also has a large space for radiation of heat on it,

3) the electric wires 80 are retained by the narrow holes 53 and bent for 90 degrees that changes the direction of the outer tensions, the application point of the outer tensions accumulates at the 90 degrees turning point and not affects the engagement between the contact plates 81 and the lead-in wires 62.

Note that the specification relating to the above embodiment should be construed as an exemplary rather than as a limitative of the present invention, with many variations and modifications being readily attainable by a person of average skill in the art without departing from the spirit or scope thereof as defined by the appended claims and their legal equivalents.

I claim:

1. A structure of the Christmas light comprising:
a tubular socket having an inlaid space in top, a pair of narrow holes symmetrically formed in opposing peripheries of bottom thereof which has about 3/4 arcuate portion having a diameter slightly less then an outer diameter of a pair of electric wires, two pairs of spaced rectangular clamps symmetrically form on two sides of the bottom thereof opposite to said narrow holes and defining a pair of narrow gaps having a width less than the outer diameter of the pair of electric wires each of which having a contact plate desposed inside said socket;
a lamp engaged within the inlaid space of said socket having a base, a bulb in the base, a pair of lead-in wires exposed outside of a bottom of the base engaged with the contact plates of the electric wires respectively, an isolation isle under said bulb and a pair of retaining holes symmetrically formed in opposing peripheries of said base;
a transparent outer cap which is diaphaneity and colorful having a reduced lower end desposed at outside of said isolation isle, a pair of wedge retaining blocks each including a plain upper surface symmetrically formed on opposing peripheries of the reduced lower end and engaged with the retaining holes of said base respectively.

2. A structure of the Christmas light comprising:
a socket having a pair of narrow holes symmetrically formed in opposing peripheries of a bottom thereof abutting two pairs of rectangular clamps spacedly formed on two side of the bottom opposite to the narrow holes to define a pair of narrow gaps therebetween, a pair of ears symmetrically formed on opposing middle peripheries of said socket each having a straight potion, an arcuate potion and a retaining hole in the arcuate potion;
a lamp inserted into a top of said socket having a base, a bulb in the base and a pair of lead-in wires exposed on a bottom of the base;
a transparent outer cap wrapped on said socket having a pair of notchs in opposing peripheries of a bottom thereof engaged with the straight portion of said ears and a pair of wedge retaining blocks including a plain top surface symmetrically formed on opposing peripheries abutting the notchs and engaged within the retaining holes of said ears;
a pair of electric wires inserted into lower end of said socket being bent for 90 degrees relative to longitudinal direction of said socket and gripped by said narrow holes and said rectangular clamps in the bottom of said socket and each having a contact plate desposed inside said socket respectively engaged with the lead-in wires of said lamps.

3. The structure as recited in claim 2 wherein said electric wires go to the opposing directions from said notchs respectively.
